(19) United States
(12) Patent Application Publication
(10) Pub. No.: US 2010/0121506 A1
(43) Pub. Date: May 13, 2010

(54) APPARATUS AND METHOD FOR AUTOMATICALLY ADJUSTING THE SAIL SURFACE EXPOSED TO THE WIND

(76) Inventors: Michele Cazzaro, Besozzo(VA) (IT); Pietro Dario Binda, Bosisio Parini (LC) (IT); Riccardo Sotgiu, Solbiate Olona (VA) (IT)

Correspondence Address: GODFREY & KAHN S.C., 780 NORTH WATER STREET, MILWAUKEE, WI, 53202, US

(21) Appl. No.: 12/544,076

(22) Filed: Aug. 19, 2009

(30) Foreign Application Priority Data
Nov. 11, 2008 (EP) 08425724.5

(51) Int. Cl. B63H 9/04; G06F 17/00

(52) U.S. Cl. 701/21

(57) ABSTRACT

An apparatus for adjusting the surface of at least one sail exposed to the wind in a boat comprising one or more detectors for sensing at least of the direction of the wind, its speed, the degree of the rolling of the boat, the frequency of the oscillations, the rolling, pitching and yawing angles and the accelerations with respect to a reference system; motorized drive means for hoisting and lowering, or else winding and unwinding at least in part the sail; a control unit programmed to automatically control the drive means of the sail in feedback based upon the detected quantity, or else following a command imparted by the skipper. A method for adjusting the surface of the sails in feedback based upon the detected quantity.

### BACKGROUND

The present disclosure refers to an apparatus and to a method for automatically adjusting the sail surface of a boat exposed to the wind.

Modern sailing boats are equipped with different types of sails. Normally, the set of sails with which a boat is equipped comprises the mainsail, the jib or the genoa, and the spinnaker. The set can also comprise other types of sails intended for a specialised use, for example for regattas or for particularly difficult weather conditions.

Some sailing boats, and in particular those of high tonnage, are also equipped with automatic navigation systems integrated with GPS detectors and motorized controls for the sails and the rudder. Such systems are able to autonomously manoeuvre the boat to follow the course set by the user. For example, U.S. Pat. No. 4,671,201 describes a system provided with sensors that detect the direction and speed of the wind, and means for adjusting the angle of attack of the sails with respect to the wind. The system operates in feedback by adjusting the angle of attack of the sails based upon the direction and speed of the wind detected by suitable sensors.

Boats can also be equipped with motorized systems for winding the sails, mainly the mainsail and the jib. The system for winding the jib, called jib furler, comprises an electric or hydraulic motor that winds the sail around a stay. The system for winding the mainsail, called mainsail furler, comprises an electric or hydraulic motor, which winds the sail in the relative seat, which can be inside the boom, or else inside the mast of the boat. The mainsail furler and the jib furler can be controlled manually by the user, or else they can be integrated with the automatic navigation system of the boat. In both cases, the operation foresees the complete winding and unwinding of the two sails, typically at the start or at the end of navigation.

As an alternative to the motorized winding of the mainsail, it can be collected and packed on the boom. Conventionally, this operation is carried out manually by the crew.

A drawback encountered during navigation, especially when there are strong or gusting winds, is the need to adjust the sail surface exposed to the wind. Conventionally, the adjustment is carried out manually by the crew of the boat, which takes care of partialising the sail surface exposed when the wind speed exceeds a threshold value or causes an excessive roll of the boat. The adjustment provides the partial winding of the mainsail and/or of the jib. For example, the mainsail is partially lowered, folded on the boom and secured by means of ropes called reefs; the jib is wound up, completely or in part, on the relative jib furler. In the case in which the boat is equipped with a mainsail furler, the sail is in part wound in the boom or in the mast, depending upon the case, so as to leave just a part of the sail exposed to the wind with respect to the overall surface.

manual adjustment of the surface of the sails is laborious and requires the intervention of at least one crew member, more often two. For example, to adjust the mainsail it is necessary to intervene on different ropes like, for example, the reef-lines, the reefs, and the sheet. In particular, the procedure comprises the steps of loosening the yang and the mainsail to minimise the thrust exerted by the wind, lowering the relative halyard until the head of the mainsail is taken to a predetermined height with respect to the mast of the boat (a nominal height for each reef point that is intended to be used), drawing in and hauling the reef-lines and/or the reefs to pull the mainsail towards the boom, placing the halyard back under tension and continuing navigation exposing the hoisted part of the mainsail to the wind and, finally, securing the lowered portion of the mainsail (i.e. the non-exposed portion).

As the wind conditions vary, the adjustment must be repeated. For example, as the wind speed increases, it may be necessary to lower the mainsail further, i.e. to use another reef point in addition to the first. The reduction in sail exposure takes time and it is almost always necessary to cut out or minimise the thrust exerted on the sails. Vice-versa, if the wind speed reduces, it is possible to completely hoist the mainsail, maximising its exposed sail surface.

The manoeuvre does, however, require the presence of at least one crew member in the cockpit of the boat or else at the base of the mast, these being positions that are not very safe in rough seas.

In addition to the manual adjustment, some boats equipped with a motorized mainsail furler provide for the automatic adjustment of the sail surface in the case of strong wind, for safety reasons. The adjustment is carried out in feedback based upon the detected value of the tension that acts upon the mainsail, i.e. based upon the intensity of the wind. A system of this type is described in U.S. Pat. No. 4,671,201.

The adjustment of the jib foresees its partial winding on the jib furler after having loosened the sail. Alternatively, in particularly difficult weather conditions, the jib is completely lowered or replaced with another jib having a smaller surface or with an even smaller sail, like for example a “storm jib”.

Disadvantageously, manual adjustment systems require the intervention of experts, with latent risks to the well-being of the crew members that actively participate in the manoeuvres; on the other hand, with reference to the automatic adjustment system described in U.S. Pat. No. 4,671,201, the Applicant has found that the market requires more effective systems in optimising the trim of the boat and, consequently, in managing on-board comfort.

### SUMMARY

The technical problem forming the basis of the present disclosure is to provide an apparatus and method that allow adjustment of the surface of the sails exposed to the wind that is effective in optimising the trim of the boat according to the comfort of the passengers on board, automatically without the intervention of the crew, or with interventions of little substance that do not jeopardise the safety of the people.

In a first aspect thereof, the present disclosure therefore concerns an apparatus for automatically adjusting the surface of the sails exposed to the wind, according to claim 1.

In particular, the present disclosure concerns an apparatus for adjusting the surface of at least one sail exposed to the wind in a boat, comprising:

one or more detectors or sensors of at least one quantity from the amplitude and/or frequency of rolling and/or pitching and/or yawing oscillations of said boat, and/or the rolling and/or pitching and/or yawing accelerations of at least one portion of said boat with respect to a reference system,

motorized or servo-assisted drive means for hoisting and lowering, or else winding and unwinding at least in part said sail;

a control unit programmed to control said drive means of the sail in feedback based upon said at least one detected quantity, automatically, or else following a manual control imparted by a crew member.

Advantageously, the apparatus according to the disclosure allows the automatic adjustment of the active surface of one or more sails of the boat, i.e. the surface exposed to the wind, based upon the wind conditions and the on-board comfort.

The reference system is fixed and may, for example, coincide with a Cartesian system having three axes. The hull of the boat moves with respect to the reference system due to the rolling, pitching and yawing movements. In an embodiment, the axes of the reference system intersect at the base of the mast of the boat, with the axis x longitudinal to the hull, the axis y transversal to it on a horizontal plane and the axis z perpendicular to the axes x and y and lying on a vertical plane, parallel to the mast of the boat when it is in stationary position. The rolling, pitching and yawing accelerations are for example detected by an accelerometer positioned on the boat, on the deck, in a central position, at the bow or at the stern. The accelerometer sends signals to the control unit indicating the accelerations undergone with respect to the reference system x,y,z, i.e. the accelerations undergone in at least one of the rolling, pitching and yawing directions.

The sail to be adjusted can be the mainsail, or else the jib; in both cases, the apparatus comprises the motorized means necessary to adjust the active surface of the sail without the manual intervention of a crew member.

In the case of the mainsail, as an example, the motorized means can comprise a mainsail furler that allows the exposed surface to be increased or decreased by even only partially winding/unwinding the sail in the boom or inside the mast of the boat. The motorized means can also comprise, in addition or as an alternative, a motorized winch for winding the sheet of the mainsail, a motorized winch for winding the halyard of the mainsail, a tensioner/motorized winch for the reef-lines of the mainsail and/or the reefs.

In the case of the jib, for example, the motorized means can comprise at least one from a motorized jib furler or a motorized winch for winding/unwinding the sheet of the jib or a manual jib furler.

By actuating the motorized drive means of the sails, individually or jointly in the typical timing for these manoeuvres, the control unit increases or reduces the active sail surface, according to discrete increments, i.e. by predetermined amounts, or else according to continuous increments, between a maximum (sail completely unfurled) and a minimum (sail completely lowered).

The area of the exposed surface of the sail is calculated by the control unit by processing the signals supplied by one or more sensors of the opening of the sail. With regard to the mainsail, preferably such sensors comprise at least one from one or more sensors of the position of the peak of the mainsail with respect to the mast of the boat and/or of the extension of the mainsail along the boom of the boat and/or of the number of revolutions made by the mainsail furler. With regard to the jib, preferably such sensors comprise one or more sensors of the position of the head of the jib with respect to the mast of the boat and/or of the number of revolutions made by the jib furler.

Preferably, the sensors are proximity sensors positioned on the mast or on the boom, or else encoders associated with the shaft of the mainsail furler or of the jib furler, or else string encoders for continuously measuring the position of the peak of the mainsail with respect to the mast.

In general, however, the signals processed by the control unit of the apparatus, and generated by the sensors, are indicative of the position of one or more portions of the sail with respect to the relative support structure, which may be the boom, the mast or a stay. Therefore, the signals of the sensors provide information regarding the opening of the sail in a given moment in time.

The control unit is programmed to increase or reduce the surface of the mainsail or of the jib exposed to the wind, according to discreet and/or continuous amounts, as the detected quantity decreases or increases, respectively. The control unit thus operates in feedback and intervenes to adjust the surface of the sails when the detected quantity exceeds a reference value, for example when the wind speed exceeds a value considered dangerous, or else when the rolling and/or pitching and/or yawing of the boat is considered of an excessive amplitude (angles) for the passengers' comfort, or else dangerous, or else in response to a manual command by the skipper.

In an embodiment of the present disclosure, the processing of the signals provided by the sensors is carried out before and after each adjustment intervention of the sails. This makes it possible to check that the motorized drive means have worked correctly and the active surface of the sails is actually the desired one. For example, the processing can comprise checking the number of revolutions completed by the mainsail furler or by the jib furler.

Preferably, the control unit of the apparatus according to the present disclosure is interfaced with an automatic navigation system of the boat. This characteristic allows the control unit to control the boat by means of the navigation system when necessary for the adjustment of the surface of the sails.

In a second aspect thereof, the present disclosure concerns a method for adjusting the surface of at least one sail exposed to the wind in a boat, according to claim 10.

In particular, the method comprises the steps of:

detecting at least one quantity from the amplitude and/or the frequency of the rolling and/or pitching and/or yawing of said boat, and/or the rolling and/or pitching and/or yawing accelerations of at least one portion of said boat with respect to a reference system;

controlling drive means of the sail, through a control unit, in feedback based upon said at least one detected quantity, automatically or else following a manual command imparted by a crew member, said drive means, motorized or servo-assisted, being suitable for hoisting and lowering, or else winding and unwinding at least in part said sail.

The adjustment of the surface of the sails of a boat according to the method described above can be obtained with the apparatus of the present disclosure.

Preferably, the method of the disclosure comprises the step of detecting, by means of one or more sensors, the position of the peak of the mainsail with respect to the mast of the boat and/or the extension of the mainsail along the boom of the boat and/or the number of revolutions made by the mainsail furler, and/or the number of revolutions made by a string encoder indicative of the extension of the mainsail. As an alternative or in addition to the aforementioned step, the method of the disclosure preferably comprises the step of detecting the position of the peak of the jib with respect to the mast of the boat and/or the number of revolutions made by the jib furler, and/or the number of revolutions made by a string encoder indicative of the extension of the jib, by means of one or more sensors.

Preferably, the method of the disclosure also comprises the step of increasing or reducing the surface exposed to the wind of said mainsail, and/or of said jib, by discrete and/or continuous amounts through said control unit, as the physical quantity detected, automatically or in response to a manual command from the skipper, respectively decreases or increases.

Preferably, the control unit is interfaced with an automatic navigation system of the boat; through the control unit the boat is manoeuvred to orientate the bow optimally with respect to the direction of the wind, to reduce the resistance exerted on the sails, during an adjustment of the sail surface exposed to the wind.

In an embodiment of the method of the present disclosure, the control unit processes the signals generated by said sensors to calculate the surface of the mainsail and/or of the jib exposed to the wind after each adjustment intervention.

Preferably, the control unit of the apparatus automatically (i.e. without the intervention of crew members) carries out the steps of:

a) detecting at least one of the aforementioned physical quantities and comparing it with a reference value and, when necessary based upon said comparison,

b) controlling the automatic navigation system to orientate the bow of the boat;

c) actuating one or more motorized drive means to adjust the surface of the sail, hoisting it and lowering it, or else winding it and unwinding it at least in part;

d) processing the signal provided by at least one of the sensors to calculate the surface of the sail actually exposed to the wind after the adjustment.

In an embodiment, steps a)-d) are followed by the step of:

e) detecting the physical quantities of interest once again and comparing them with the reference values and repeating steps a-d, when necessary based upon such a comparison.

Optionally, the control unit can generate a signal, for example visual, acoustic, etc., to warn the skipper that conditions have been detected that require the adjustment of the exposed sail surface. The control unit can be programmed to autonomously control the adjustments when, after a predetermined time period, the skipper has not intervened with a manual control, or else it can be programmed to not proceed and wait for the intervention of the skipper who can decide whether to agree to the variation of the exposed sail surface, with a manual control imparted through a control panel.

Preferably, the skipper can at any time intervene on the operation of the control unit, modifying its programs, cancelling the set adjustments and taking over from the adjustment method followed by the unit itself. The skipper can impart manual commands to the control unit to adjust the sails as desired.

The control unit can thus operate completely automatically (full automatic mode), but preferably at the same time allows the intervention of the skipper in the adjustment procedures (semi automatic or full manual mode).

### BRIEF DESCRIPTION OF THE DRAWINGS

Further characteristics and advantages of the present disclosure shall become clearer from the following detailed description of some preferred embodiments thereof, made with reference to the attached drawings. In such drawings,

FIG. 1 is a side view of a sailing boat equipped with an apparatus according to the present disclosure;

FIG. 2 is a schematic side view of a mainsail equipped according to the present disclosure.

### DESCRIPTION

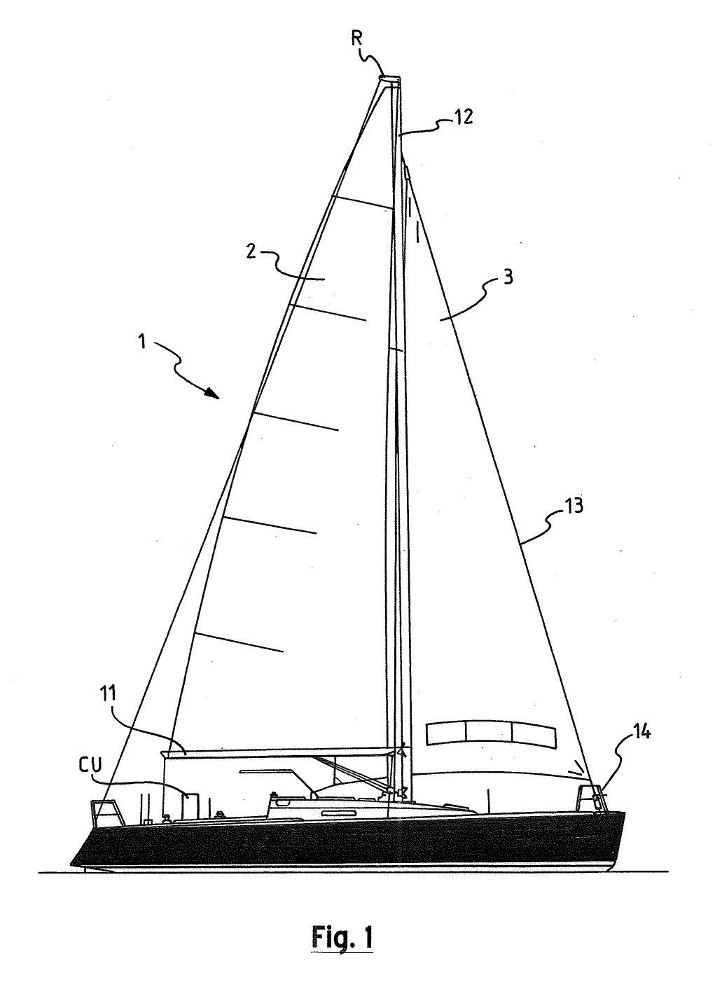

FIG. 1 shows a sailing boat 1 equipped with a mainsail 2 and a jib 3. In the figure the sails 2 and 3 are shown completely unfurled. The mainsail 2 is supported on the mast 12 and on the boom 11; the jib is hoisted along a bow stay 13, in turn fixed at the top to the mast 12.

The actuation of the sails 2 and 3 is motorized, i.e. the boat 1 is equipped with motorized drive means of the sails 2 and 3. At the bow there is a jib furler 14, with motorized actuation, which has the function of winding the sail around the relative stay. The sheet of the jib 3 is hauled or surged manually and/or by motorized winches. The mainsail 2 can be completely manual, but preferably it is associated with a mainsail furler inside the boom 11 or the mast 13. In the example shown in FIG. 1 the mainsail 2 is manual, or else able to be wound inside the boom 11, or furthermore it can be packed above the boom 11. The sheet of the mainsail 2 is actuated by motorized controls, for example motorized or servo-assisted winches, having the function of hoisting or lowering the sail.

The boat 1 is equipped with an apparatus according to the present disclosure for adjusting the surface of at least one sail 2 or 3, i.e. the active surface exposed to the wind.

The apparatus comprises one or more detectors R of the wind conditions, for example the direction and speed of the wind with respect to the boat 1, or else detectors of dynamic behaviour, for example the size of the oscillations or the frequency of the rolling, pitching and yawing movements of the boat 1. The detectors can be anemometers, accelerometers, gyroscopes, etc., and are, for example, positioned at the top of the mast 12, or else at the bow, or the stern or at the base of the mast. The detectors R generate electrical and/or radio signals indicative of the physical quantity measured.

Preferably, the accelerations are measured with respect to a stationary reference system, for example a reference system using three Cartesian axes x, y, z that intersect ideally at the base of the mast of the boat considered in stationary position and perfectly horizontal. The sensors, for example accelerometers, detect the accelerations undergone with respect to the stationary reference system x, y, z.

A control unit CU of the apparatus, shown schematically in FIG. 1, receives the signals sent by the detectors R and processes them. In particular, the control unit CU compares the detected values of the physical quantities with reference values and bases upon this comparison attributes a danger level to the wind conditions, and/or an on-board comfort level. If the wind speed exceeds a predetermined threshold value, the wind conditions are considered dangerous for navigation and the control unit CU is activated to carry out an adjustment of the exposed surface of the sail 2, or else of the sail 3 or of both. Similarly, if the rolling and/or pitching and/or yawing movements of the boat 1 cause oscillations of greater amplitude (angle) than a threshold value, or else having a frequency above/below a threshold value, or a heel considered excessive, the control unit intervenes to adjust the active sail surface and restore the best conditions of on-board comfort and safety.

unit CU is interfaced or in any case connected with the motorized control means of the sails 2, 3, like for example the mainsail furler, the jib furler 14, motorized winches, winders of the sheets, of the reefs, of the reef-lines, etc. The adjustment of the sails 2 and/or 3 is carried out by the control unit CU in feedback based upon the processing of the signals received from the detectors R or from other sensors S1, S2, . . . Sn installed in the mast 12, in the on-board equipment or in the motorized devices themselves.

For example, if the wind causes rolling of greater amplitude than a reference value, i.e. oscillations that reduce the comfort of the passengers on-board the boat 1, the control unit CU actuates the motorized drive means of the sails to reduce the sail surface exposed to the wind, for example it partially lowers or winds up the mainsail 2 to take in a reef, or else it partially or completely lowers or winds up the jib 3.

In low-wind conditions, it may be that the wave motion causes rapid rolling of the boat 1, i.e. oscillations of small size by having high frequency, or in any case a frequency considered sufficient to create unfavourable conditions for the comfort of the passengers. In these circumstances the control unit CU can be programmed to increase the sail surface exposed to the wind. For example, the control unit CU can completely hoist the mainsail, or else it can take in the reefs at a lower reef point. The increase in active sail surface increases lift and stabilises the boat, reducing the frequency of rolling.

In general, the control unit CU is programmed to increase or reduce the surface of the sails 2 and/or 3 exposed to the wind, according to pre-set criteria, to maximise comfort on the boat or to maximise the performance at a certain point of sailing.

The control unit CU, for example an electronic control unit, can be programmed to operate completely automatically, or else semi-automatically, with the possibility of intervention by the skipper through a user interface.

Preferably, the apparatus comprises one or more sensors of the active surface of the sail. In other words they are sensors that detect the position of the sail with respect to the relative support structure.

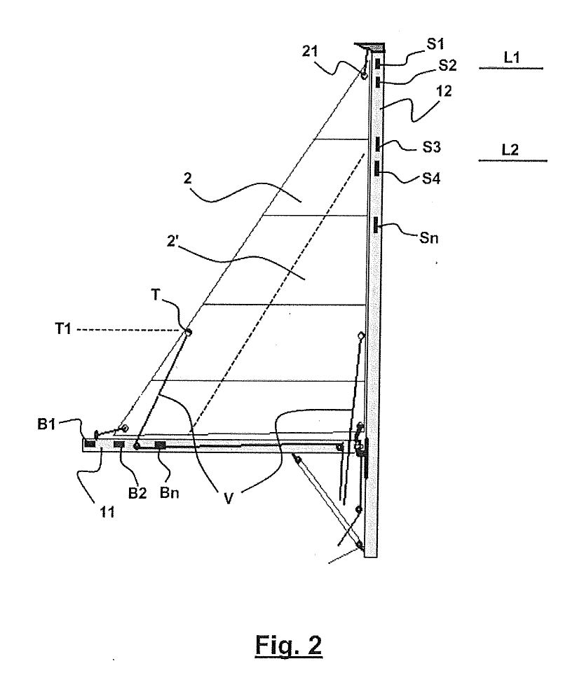

FIG. 2 is a diagram of the mainsail 2 completely hoisted. At the top of the mast 12 there is at least one sensor S1, but preferably there are two or more sensors S2, S3, S4, . . . , S_{N} that detect the position of the peak 21 of the mainsail 2 with respect to the mast 12. In other words, the sensors S1-S_{N} send to the control unit CU a signal relative to the height of the head 21 of the mainsail, i.e. relative to the vertical extension of the sail 2. As an alternative or in addition to the sensors S1-S_{N}, other similar sensors B1-B_{N} can be positioned on the boom 11 to detect the horizontal extension of the sail 2. The sensors S1-S_{N} are preferably proximity sensors, for example electrical (inductive, capacitive, etc.), magnetic or optical.

Alternatively, the apparatus comprises a sensor intended to continuously measure (and not at discreet increments) the position of the peak along the mast, for example a string encoder, or similar devices.

Preferably, the apparatus comprises a tensioning device of the reef-lines V, or it can be interfaced with a tensioning device available on the boat 1. The tensioning device (not shown) comprises suitable sensors for detecting the tension applied to the reef-lines. The relative signal is sent to the control unit CU for processing.

Preferably, the control unit CU calculates the sail surface actually exposed to the wind by processing the signals received for example from the proximity sensors S1-S_{N} and/or B1-B_{N}. This check can be completed before and after each adjustment intervention.

Again with reference to FIG. 2, the two reef-liness V are shown, also adjustable by the control unit CU by means of motorized controls and/or by means of the relative tensioning device. When the mainsail 2 is reduced, i.e. when a set of reef is taken in, the peak 21 of the mainsail is lowered for example from level L1 to level L2. The reef-liness V are pulled and the mainsail 2 takes up the configuration 2′ indicated with the broken line. In practice, the portion of the mainsail 2 that is located below the line T1 of the eyelet holes T of the reefs is wound by the mainsail furler in the boom 11, or else it is locked on the boom 11 with the reefs.

Preferably, the control unit CU is interfaced with an automatic navigation system of the boat 1. This characteristic allows the control unit to autonomously control the boat 1, i.e. without the intervention of the crew, during the adjustment manoeuvres of the sails 2 and/or 3. Preferably, the control unit CU interfaces with the navigation system to orientate the bow of the boat 1 in the optimal direction with respect to the wind. This manoeuvre allows the force exerted by the wind on the sails 2 and 3 to be minimised, i.e. it makes it possible, for example, for the sails to shake in the wind “flag-style”.

As an example, a procedure carried out by the apparatus according to the disclosure to reduce the mainsail 2 comprises the steps of: orienting the bow of the boat 1 to about 40° with respect to the direction of the wind, loosening the sheet of the mainsail 2 by means of the relative motorized winch, completely lowering the mainsail 2, or else partially lowering it taking the head 21 from level L1 to level L2, checking with the sensors S3 and S4 that the head is actually at the desired level, winding the bottom portion of the mainsail 2 into/onto the boom 11, tensioning the reef-lines V and possibly the reefs, placing the mainsail 2 back under tension, hauling the relative sheet and returning to the initial course.

Preferably, after the adjustment has been carried out, the apparatus continues to process the signals generated by the detectors R to check whether the adjustment has been effective with respect to the results that one wishes to obtain (greater safety, higher performance of the boat, greater comfort). When necessary, based upon the comparison carried out by the control unit CU, another adjustment is carried out.

The mainsail furler is preferably provided with sensors, for example encoders, that detect the number of revolutions made by the shaft. In this way the control unit CU is able to calculate the surface of the mainsail 2 that has actually been wound in the boom 11.

Preferably, the apparatus also comprises sensors that detect the amount of rope released to loosen the mainsail 2 and/or the jib 3.

The apparatus according to the present disclosure has an application in the case in which the mainsail 2 can be wound/lowered into/onto the boom 11 or can be wound into the mast 12.

The adjustment of the jib is equivalent. For example, the jib furler 14 can be provided with an encoder that detects the revolutions made; this quantity is proportional to the exposed sail surface.

The apparatus according to the present disclosure can comprise load sensors arranged to detect the tension applied to the sheet of the jib or to the relative halyard.

Preferably, the adjustment of the sails 2 and 3 is carried out by the apparatus according to the present disclosure completely automatically, or else with the intervention of a crew member, increasing or reducing the exposed surface of the sails by discreet amounts.

The advantages offered by the apparatus according to the present disclosure are many. The apparatus allows the completely automatic adjustment of the surface exposed to the wind of the sails and allows safety and comfort of navigation to be maximised, or else it allows the sequence of manoeuvres necessary for the adjustment of the active surface of the sails to be carried out automatically following a command imparted by the skipper.

1. An apparatus for adjusting the surface of at least one sail exposed to the wind, in a boat, comprising:
one or more detectors of at least one quantity from amplitude and frequency of rolling, pitching, and yawing oscillations of said boat, and rolling, pitching and yawing accelerations of at least one portion of said boat with respect to a reference system;
motorized or servo-assisted drive means, for hoisting and lowering, or else winding and unwinding at least in part said sail;
a control unit programmed to control said drive means of the sail in feedback based upon said at least one quantity detected automatically or else following a manual command imparted by a crew member.

2. The apparatus of claim 1, characterised in that said sail is a mainsail and said motorized drive means comprise at least one of a motorized mainsail furler, a motorized winch for winding the halyard of the mainsail, a motorized winch for winding the sheet of the mainsail, a tensioner/motorized winch for the reef-lines of the mainsail and/or of the reefs.

3. The apparatus of claim 2, characterised in that it also comprises one or more sensors for detecting at least one of the position of the peak of the mainsail with respect to the mast of the boat, the extension of the mainsail along the boom of the boat, the number of revolutions carried out by the mainsail furler, and the amount of rope released to sheet the sail.

4. The apparatus of claim 1, characterised in that said sail is a jib and said motorized drive means comprise at least one from a motorized jib furler and a motorized winch for winding the sheet of the jib.

5. The apparatus of claim 4, characterised in that it also comprises one or more sensors of the position of the peak of the jib with respect to the mast of the boat, the number of revolutions made by the jib furler, and the amount of sheet released to sheet the jib.

6. The apparatus of claim 3, characterised in that each of said sensors are one of a proximity sensor positioned on one of the mast or the boom, an encoder associated with the shaft of the mainsail furler, and a string encoder for continuously measuring the position of the peak.

7. The apparatus of claim 2, characterised in that said control unit is programmed to increase or reduce the surface exposed to the wind of said sail, by one of discrete and continuous amounts, as said at least one detected quantity decreases or increases, respectively.

8. The apparatus of claim 7, characterised in that said control unit processes the signals generated by said sensors to calculate the surface of said sail exposed to the wind after each adjustment intervention.

9. The apparatus according to claim 1, characterised in that said control unit is interfaced with an automatic navigation system of the boat.

10. A method for adjusting the surface of at least one sail exposed to the wind, in a boat, comprising the steps of:
providing one or more detectors;
detecting at least one quantity from the amplitude and frequency of the rolling, pitching and yawing oscillations of said boat, and the rolling, pitching and yawing accelerations of at least one portion of said boat with respect to a reference system;
controlling drive means of the sail, through a control unit, in feedback based upon said at least one detected quantity, automatically or else following a manual command imparted by a crew member, said control means, motorized or servo-assisted, being suitable for hoisting and lowering, or else winding and unwinding at least in part said sail.

11. The method of claim 10, characterised in that at least one of the position of the peak of the mainsail with respect to the mast of the boat, the extension of the mainsail along the boom of the boat, the number of revolutions made by the mainsail furler and by a string encoder associated with a portion of said sail is detected by means of one or more sensors.

12. The method of claim 10, characterised in that at least one of the position of the peak of the jib with respect to the mast of the boat, the number of revolutions made by the jib furler and by a string encoder is detected by means of one or more sensors.

13. The method of claim 10, characterised by the step of increasing or reducing, through said control unit, the surface exposed to the wind of said sail, by one of discrete and continuous amounts, as said physical quantity detected automatically or following a manual command imparted by a crew member respectively decreases or increases.

14. The method according to claim 13, characterised by the further steps of interfacing said control unit with an automatic navigation system of the boat and orienting the bow of the boat, through said control unit, in an optimal way with respect to the direction of the wind during an adjustment of the surface of said sail exposed to the wind.

15. The method of claim 13, characterised in that said control unit processes the signals generated by said one or more detectors to calculate the surface of said at least one sail exposed to the wind following each adjustment intervention.

16. The method of claim 15, characterised in that said control unit automatically carries out the steps of:
a) detecting said at least one quantity and comparing it with a reference value and, when necessary based upon said comparison,
b) controlling said automatic navigation system to orient the bow of the boat in an optimal way with respect to the direction of the wind;
c) actuating one or more of said motorized drive means to adjust the surface of the sail, hoisting it and/or lowering it, or else winding it and unwinding it at least in part;
d) processing the signal provided by at least one of said sensors to calculate the surface of the sail actually exposed to the wind after the adjustment;

17. The method of claim 16, characterised by the further step of:
e) detecting said at least one quantity once more and comparing it with said reference value and repeating steps a-d, when necessary based upon said comparison.
